(19) United States
(12) Patent Application Publication
(10) Pub. No.: US 2024/0219295 A1
(43) Pub. Date: Jul. 4, 2024

(54) A METHOD AND AN OPTICAL SYSTEM FOR MONITORING A PARAMETER OF A FLUID IN A HOLLOW CORE OF AN OPTICAL FIBER

(71) Applicant: NKT Photonics A/S, Birkerød (DK)

(72) Inventors: Peter Moselund, Birkerød (DK); Rasmus Engelsholm, Birkerød (DK); Erik Nicolai Christensen, Birkerød (DK)

(21) Appl. No.: 18/555,438

(22) PCT Filed: Apr. 11, 2022
(86) PCT No.: PCT/DK2022/050077

§ 371 Date: Oct. 13, 2023

(30) Foreign Application Priority Data
Apr. 16, 2021 (DK) PA202170178

(51) Int. Cl. G01N 21/17; G02F 1/365

(52) U.S. Cl. CPC G01N 21/1702; G02F 1/365; G01N 2021/1706; G01N 2201/06113; G01N 2201/088

(57) ABSTRACT

Disclosed is an optical system for monitoring a parameter, such as a density or a pressure, of a fluid, in particular a gas or a mixture of gases, in a hollow core of an optical fiber, wherein the optical system comprises: an optical fiber which comprises a hollow core that is filled with a fluid, a pulsed laser for providing pulsed laser light, which is input into a first end of the optical fiber such that the laser light propagates through the hollow core from the first end to a second end of the fiber, wherein the pulsed laser light is configured to induce nonlinear processes by interacting with the fluid in the hollow core, and wherein the optical system further comprises a monitoring device for detecting acoustic vibrations in the fiber and for determining a parameter of the fluid based on the acoustic vibrations.

The present invention relates to a method and an optical system for monitoring a parameter, such as a density or a pressure, of a fluid in a hollow core of an optical fiber.

In optical fibers with a hollow core that is filled with a fluid, nonlinear optical processes, e.g. supercontinuum generation, four wave mixing (FWM) or self-phase modulation (SPM), can occur during the interaction of pulsed laser radiation with the fluid. For such processes, the density and/or the pressure of the fluid in the hollow core of the fiber is a critical parameter for the stability and control of the processes.

In order to stabilize nonlinear optical processes occurring in the fluid of a hollow core optical fiber, it is desirable to stabilize the density of the fluid in the hollow core and in particular in the region where interaction between fluid and laser pulses occurs. This stabilization can be customarily done by using a pressure sensor and a temperature sensor and from the signals obtained from the two sensors, the fluid density can be calculated.

However, the temperature in the fluid may vary and may depend on the position in the hollow core where the temperature is measured. Thus, the temperature can have gradients. Thus, the temperature of the fluid at the temperature sensor may not correspond to the temperature of the fluid in an optical interaction volume in which interaction between laser pulses and fluid takes place.

Furthermore, pressures only propagate with a finite speed which is low compared to the propagation speed of optical and electric signals. Thus, the pressure read out by a pressure sensor may have a time delay compared to the pressure of the gas in the optical interaction zone. Moreover, if a mechanically based pressure sensor is used this typically involves thin barriers to volumes with low pressure and such thin barriers may cause a leakage of fluid which reduces the stability of the fluid density in the volume of the hollow core, in particular at locations where optical processes occur.

It is therefore an object of the present invention to provide an improved method and system that can determine or monitor a parameter, such as density or pressure, of a fluid in the hollow core of an optical fiber more accurately.

In some embodiments of the invention, a method of monitoring a parameter, such as a density or a pressure, of a fluid, in particular a gas or a mixture of gases, in a hollow core of a hollow core optical fiber comprises:
providing an optical fiber which comprises a hollow core that is filled with a fluid, providing laser light from a laser,
inputting the laser light from the laser into a first end of the fiber such that the laser light propagates through the hollow core from the first end to a second end of the fiber, thereby obtaining output laser light from the laser which is output at the second end of the fiber, and
determining a parameter, such as a density or a pressure, of the fluid in the hollow core based on the output laser light.

The method uses laser light that propagates through the hollow core of the optical fiber to determine the parameter, in particular the density, of the fluid in the hollow core. Therefore, a near-instantaneous non-contact method for monitoring the fluid parameter and in particular the fluid density in the hollow core and hence in the optical interaction volume is provided.

In a hollow core optical fiber, the fluid can be used as a medium which interacts with strong laser pulses from a further, second laser. Due to nonlinear effects caused by interactions between the strong laser pulses and the fluid, nonlinear optical processes, such as, but not limited to, supercontinuum generation, four wave mixing (FWM) or self-phase modulation (SPM), can occur. The strong laser pulses from the second laser also can travel along the hollow core, in the same or in the opposite direction as the laser light provided by the laser which is used to measure or monitor the parameter of the fluid. Thus, an optical measurement method is provided which can serve to measure and monitor the fluid density in the hollow core in which the measurement of the fluid density is based on the interaction between the fluid and light propagating along the same axis as the light undergoing nonlinear processes in the hollow core fiber. The fluid density in the hollow core of the fiber can therefore be controlled accurately. Correspondingly, nonlinear processes occurring in the hollow core can be controlled in an improved way.

In some embodiments, the method comprises separating a portion from the laser light before it is input into the first end of the fiber and not inputting the separated portion of the laser light into the fiber, and determining the parameter, such as the density or pressure, of the fluid in the hollow core based on differences in e.g. propagation speed of the separated portion of the laser light and the output laser light. The separated portion of laser light can be guided around the hollow core and it can be superposed with the output laser light or a portion thereof.

In some embodiments, the step of determining the parameter of the fluid in the hollow core comprises monitoring an interaction, in particular an interference, between the separated portion of the laser light and the output laser light. The parameter can be derived in dependence on the interference between the separated portion of the laser light and the output laser light.

In particular, the interference can be used to determine an optical delay or, correspondingly, a phase shift, between the separated portion of laser light and the output laser light. The optical refractive index of the fluid is dependent on its density. The optical delay that is measured from an interference between the separated portion of laser light and the output laser light therefore is not only dependent on different path lengths covered by the separated portion of laser light and the output laser light, but also on the optical density of the fluid in the hollow core. Moreover, when the fluid density changes its refractive index changes and thereby the optical delay through the fiber changes. By monitoring the interaction between a tap of the input and output pulses one can thereby monitor changes in the fluid density.

Thus, in some embodiments, the step of determining the parameter of the fluid in the hollow core can comprise a step of determining an optical delay between the separated portion of the laser light and the output light, and a step of determining the parameter and in particular the density of the fluid in the hollow core based on the determined optical delay.

In some embodiments, a phase shift of the output light is monitored and the density of the fluid is determined based on the monitored phase shift. The monitored phase shift or, correspondingly, an optical delay of the output light might be used to determine a refractive index of the fluid in the fiber, and the refractive index might be used to determine the density of the fluid. Monitoring changes of the phase shift over time further serve to monitor changes of the density of the fluid over time.

In some embodiments, a wavelength of the input light is modulated over time. In particular, the wavelength can be swept across an absorption wavelength of the fluid, and the output light might be used to determine a width of the absorption line and/or a center wavelength of the absorption line. Furthermore, the determination of the density of the fluid might be based on the width of the absorption line and/or the center wavelength of the absorption line.

In particular, a continuous wave (CW) or quasi-CW laser can be co-propagated or counter propagated along the axis of the hollow core in conjunction with laser pulses that undergo nonlinear processes due to interaction with the fluid in the hollow core. The phase shift of this CW laser can be monitored and thereby the optical delay, refractive index and density of the fluid in the interaction volume may be monitored.

In some embodiments, the wavelength of the CW laser may be wavelength modulated and in some embodiments this wavelength modulation is performed in proximity to a fluid absorption line of one of the gases of the fluid in the interaction volume. A detected wavelength broadening and position of the absorption line may then be used to calculate pressure and temperature of the fluid.

In some embodiments, a method of monitoring a parameter, such as a density or a pressure, of a fluid, in particular a gas or a mixture of gases, in a hollow core of an optical fiber comprises:
providing an optical fiber which comprises a hollow core that is filled with a fluid, providing pulsed laser light from a laser,
inputting the pulsed laser light into a first end of the optical fiber such that the laser light propagates through the hollow core from the first end to a second end of the fiber, wherein the pulsed laser light is configured to induce nonlinear processes by interacting with the fluid in the hollow core,
measuring, in particular by use of one or more transducers at one or more positions on the outer surface of the fiber, acoustic vibrations occurring in the fiber, and determining a parameter of the fluid based on the measured acoustic vibrations.

Thus, at least in some embodiments, a portion of the energy in the pulses of the laser undergoing nonlinear processes in the hollow core fiber will be absorbed in the fluid and in the material (e.g. glass) surrounding the hollow core of the fiber. This absorption can give rise to a temperature change and thermal expansion of the volume in which it is absorbed. This expansion can in turn give a pressure wave, which propagates partly in the fluid and partly in the material of the fiber. The propagation speed of the pressure wave in the fluid depends on the temperature of the fluid and will be partially be transferred to the material. If the acoustic vibrations in the material are monitored, for example with a transducer, at one or more positions on the outside of the fiber, it is possible to infer a parameter, such as the temperature or pressure, of the fluid through this photoacoustic measurement method.

In some embodiments, a propagation speed of pressure waves which can occur in the fluid in the hollow core is determined based on the acoustic vibrations. The propagation speed of the acoustic vibrations might further be determined based on a signal obtained from the pulsed laser light.

The laser light can be pulsed, quasi-continuous or continuous laser light.

The invention also relates to an optical system for monitoring a parameter, such as a density or a pressure, of a fluid, in particular a gas or a mixture of gases, in a hollow core of an optical fiber, the system comprises:
an optical fiber which comprises a hollow core that is filled with a fluid,
a laser for providing laser light, which is input into a first end of the fiber such that the laser light propagates through the hollow core from the first end to a second end of the fiber and output laser light from the laser is obtained at the second end of the fiber, and
a monitoring device configured to determine a parameter, such as a density or a pressure, of the fluid in the hollow core based on the output laser light.

The optical system can comprise at least one optical element for separating a portion from the laser light before it is input into the first end of the fiber and for bypassing the laser light around the fiber, and the monitoring device can be configured to determine the parameter of the fluid in the hollow core based on the separated portion of the laser light and the output laser light.

The monitoring device can be configured to monitor an interaction between the separated portion of the laser light and the output laser light. In particular, the monitoring device can be configured to monitor an interference between the separated portion of the laser light and the output laser light.

In some embodiments, the monitoring device can be configured to determine an optical delay between the separated portion of the laser light and the output light, and further to determine the parameter of the fluid in the hollow core based on the determined optical delay.

In some embodiments, the monitoring device is configured to determine a phase shift of the output laser light and to determine the parameter of the fluid based on the monitored phase shift.

In some embodiments, the monitoring device is configured to determine an optical delay of the output laser light due to its propagation in the fiber, to determine a refractive index of the fluid in the fiber based on the optical delay, and to determine the parameter of the fluid based on the refractive index.

The optical system can be configured to modulate a wavelength of the input light over time.

In some embodiments, the optical system can be configured to sweep the wavelength across an absorption wavelength of the fluid, and the monitoring device can be configured to determine a width of the absorption line and/or a center wavelength of the absorption line, and to determine the parameter of the fluid based on the width of the absorption line and/or the center wavelength of the absorption line.

The laser can be a pulsed laser, a quasi-continuous (quasi-CW) or a continuous laser (CW-laser).

The optical system can comprise at least a second laser for providing second laser light which can be input into the hollow core of the fiber to cause the generation of nonlinear processes in the fluid, wherein the second laser light propagates in the same direction or in the opposite direction through the hollow core as the input laser light.

The invention also relates to an optical system for monitoring a parameter, such as a density or a pressure, of a fluid, in particular a gas or a mixture of gases, in a hollow core of an optical fiber, wherein the optical system comprises:
an optical fiber which comprises a hollow core that is filled with a fluid,
a pulsed laser for providing pulsed laser light, which is input into a first end of the optical fiber such that the laser light propagates through the hollow core from the first end to a second end of the fiber, wherein the pulsed laser light is configured to induce nonlinear processes by interacting with the fluid in the hollow core, and
the optical system further comprises a monitoring device for detecting acoustic vibrations in the fiber and for determining a parameter of the fluid based on the acoustic vibrations.

The optical system can comprises one or more transducers, preferably arranged at one or more positions on the outer surface of the fiber, wherein the transducers are configured to detect the acoustic vibrations.

In some embodiments, the monitoring device is configured to determine the density of the fluid based on the acoustic vibrations and/or on a pressure obtained from the acoustic vibrations.

In some embodiments, the monitoring device is configured to determine a propagation speed of pressure waves in the fluid based on the measured acoustic vibrations.

The monitoring device can be configured to determine the propagation speed based on a signal obtained from the pulsed laser light.

In some embodiments, the fluid is arranged in the hollow core of the optical fiber in a gas-tight fashion.

In some embodiments, the optical fiber is an anti-resonant hollow core fiber or a hollow core photonic bandgap fiber.

In one embodiment, the non-linear processes are related to self-phase modulation that occur during the interaction of pulsed laser radiation with the fluid, and wherein a location of the self-phase modulation along the optical fiber is configured to be controlled by a peak power of the pulsed laser. Self-phase modulation is another word for soliton self-compression. When soliton self-compression, or self-phase modulation occurs, the light intensity may increase, such as by an order of magnitude.

Accordingly, in another embodiment, the induced self-phase modulation at the controlled location along the optical fiber provides an increase in light intensity. When this happens, a pressure wave, and thereby an acoustic field, may be induced at the controlled location. The self-phase modulation may take place over a short distance within the optical fiber.

As described above, a pressure wave may be induced by self-phase modulation. In another embodiment, a pressure wave may be induced by multi-photon absorption in the optical fiber. This may happen once the pulses of the laser light have sufficiently high peak power. Multi-photon absorption may happen as a consequence of self-phase modulation. However, multi-photon absorption may be independent from self-phase modulation. Accordingly, in one embodiment, and due to nonlinear effects caused by interactions between the strong laser pulses and the fluid, nonlinear optical processes, such as multi-photon absorption may occur.

Thus, in one embodiment, the non-linear processes are related to multi-photon absorption that occur during the interaction of pulsed laser radiation with the fluid, and wherein a location of the multi-photon absorption along the optical fiber is configured to be controlled by a peak power of the pulsed laser.

In a related embodiment, the induced multi-photon absorption at the controlled location along the optical fiber provides an increase in light intensity, such that a pressure wave, and thereby an acoustic field, is induced at the controlled location.

In another embodiment, the induced soliton self-compression or self-phase modulation and the induced multi-photon absorption at the controlled location along the optical fiber provides an increase in light intensity, such that a pressure wave, and thereby an acoustic field, is induced at the controlled location. The controlled location of the soliton self-compression or the self-phase modulation may be controlled by controlling a chirped pulse in the fiber. By controlling the locating of the soliton self-compression, it is possible to control where in the fiber the self-compression takes place, and thereby control the location of the multi-photon absorption. This is possible when the multi-photon absorption is dependent on the soliton self-compression or the self-phase modulation.

Based on the principle of operation, as disclosed in the above embodiments, it may be stated that the induced pressure wave, thereby the acoustic field, induced by self-phase modulation and/or multiphoton absorption, is a photo-acoustic effect taking place in the optical fiber.

In a preferred embodiment, the optical system comprises a controller to control the peak power of the pulsed laser, such that the self-phase modulation and/or the multi-photon absorption is induced along the optical fiber in a controllable manner. In other words, in this preferred embodiment, it is possible to scan the self-phase modulation and/or the multi-photon absorption through the fiber. By monitoring the induced pressure wave, i.e. the acoustic field, while scanning through the fiber, it may for example be possible to detect the temperature and/or pressure throughout the fiber. Alternatively, or additionally, it may be possible to detect the ratio of temperature and pressure throughout the fiber. As described above, the monitoring device is for detecting the acoustic vibrations, i.e. the induced pressure wave(s), in the fiber,

In most embodiments, the scanning speed of the optical system is defined by the speed of the repetition rate of the pulsed laser. Accordingly, by the present disclosure, it is possible to scan though the optical fiber at the speed of the repetition rate of the pulsed laser.

In another embodiment, the optical system comprises a second pulsed laser for providing second pulsed laser light, which is input into the second end of the optical fiber such that the laser light propagates through the hollow core from the second end to the first end of the fiber, wherein the second pulsed laser light is configured to induce nonlinear processes related to self-phase modulation that occur during the interaction of pulsed laser radiation with the fluid, and wherein a location of the self-phase modulation along the optical fiber is configured to be controlled by a peak power of the second pulsed laser. In this embodiment, there may be generated two a pressure waves, and thereby two acoustic fields, one for each of the two pulsed lasers.

In a preferred embodiment, the optical system comprises a second controller to control the peak power of the second pulsed laser, such that the self-phase modulation is induced along the optical fiber in a controllable manner. In this embodiment, the two controllers may be configured to control the two acoustic fields such that they overlap at one or more locations in the fiber. The two acoustic fields may overlap one or more pulses at one or more frequencies in one or more modes at one or more locations in the optical fiber. Accordingly, the present disclosure provides configurable and/or adaptable detection schemes that may be configured by the two lasers and/or the controllers for the two pulses lasers.

As a matter of fact, the inventors of the present disclosure have found that, in some embodiments, an overlap of two acoustic fields, may be provided in many other ways. For example, in one embodiment, two or more lasers providing first and second or more pulsed laser light, may be provided with input into the first end of the optical fiber such that the laser light from the two or more lasers propagates through the hollow core from the first end to the second end of the fiber, wherein said pulsed laser light is configured to induce nonlinear processes related to self-phase modulation that occur during the interaction of pulsed laser radiation with the fluid. The two or more lasers, may be configured with or without laser(s) having input at the second end of the fiber. Accordingly, in one embodiment, the optical system comprises two pulsed lasers providing pulsed laser light which is input into the first end of the optical fiber such that the laser light propagates through the hollow core from the first end to the second end of the fiber,

In some embodiments, the optical system comprises a second or more pulsed lasers for providing second pulsed laser light, wherein the second pulsed laser light is configured to induce nonlinear processes related to multi-photon absorption that occur during the interaction of pulsed laser radiation with the fluid, and wherein a location of the multi-photon absorption along the optical fiber is configured to be controlled by a peak power of the second or more pulsed laser and/or a time delay between the pulses of the pulsed laser light and the second pulsed laser light, wherein the second pulsed laser light is (a) input into the first end of the optical fiber such that the laser light propagates through the hollow core from the first end to the second end of the fiber, or (b) input into the second end of the optical fiber such that the laser light propagates through the hollow core from the second end to the first end of the fiber.

In other embodiments, the optical system comprises three or four pulsed lasers providing pulsed laser light which is input into the first end of the optical fiber such that the laser light propagates through the hollow core from the first end to the second end of the fiber, In yet another embodiment, the optical system comprises two pulsed lasers providing pulsed laser light which is input into the first end of the optical fiber such that the laser light propagates through the hollow core from the first end to the second end of the fiber, and two pulsed lasers providing pulsed laser light which is input into the second end of the optical fiber such that the laser light propagates through the hollow core from the second end to the first end of the fiber,

In other embodiments, two or more laser pulses are injected in one or more different spatial and/or frequency modes of the optical fiber. The pulses may be with a variable time delay, for example to control a local increase in peak power at a desired point in the fiber. The increased peak power may induce a local acoustic field through multi photon absorption at the desired point.

In most embodiments, the fluid in the hollow core of an optical fiber is a gas or a mixture of gases.

In some embodiments, the gas is ionized. An ionized gas may induce a pressure wave in a more efficient manner.

In some embodiments, the mixture of gases comprises a volatile but stable mixture of gases. For example, the volatile but stable mixture of gases may be one or more peroxides (such as H₂O₂) mixed with Oxygen (O₂).

In other embodiments, the mixture of gases is photochemically active. A mixture of gases of H₂O₂ mixed with O₂ is an example of a photochemically active mixture of gases.

An advantage of using a photochemically active mixture of gases is that such mixture may be ignited, and thereby making a strong photoacoustic signal. However, to ignite the photochemically active mixture of gases, a femtosecond pulsed laser may be needed, preferably with high power.

Accordingly, in some embodiments, the pulsed laser is a femtosecond pulsed laser, and the fluid in the optical fiber is a mixture of gases, wherein the mixture of gases is photochemically active, and wherein the pulsed laser is configured to ignite the mixture of gases.

In other embodiments, the non-linear processes are related to phonon-excitation that occur during the interaction of pulsed laser radiation with the fluid, and wherein the phonon-excitation along the optical fiber is configured to be dependent on the spatial shape of the beam of the pulsed laser.

For example, the spatial shape of the beam may, in some embodiments, provide higher order core modes or cladding modes. Accordingly, the pulsed laser may be configured to provide higher order core modes or cladding modes. An advantage of providing higher order core modes or cladding modes is that these modes may enhance nonlinear response and sensing sensitivity in hollow core fiber. This may be due to these modes excite selective phonon-modes of the fluid.

When phonons of the fluid are excited in the optical fiber, the phonons may cause scattered light inside the fiber, for example Brillouin scattering and/or Raman scattering.

The phonon distribution, and thereby the amount of scattering, is dependent on for example the pressure of the fluid and/or the temperature of the fluid.

Accordingly, by measuring the amount of scattering, it is possible to measure the phonon-distribution, and thereby the acoustic vibrations as generated by the phonons.

To measure the amount of the phonons, the amount of scattering may be measured, particularly such that a parameter of the fluid is determined based on the acoustic vibrations. According to the present disclosure, the optical system comprises a monitoring device for detecting acoustic vibrations in the fiber and for determining a parameter of the fluid based on the acoustic vibrations. In the present embodiment related to excitation of phonons, the monitoring device for detecting acoustic vibrations in the fiber may comprise a probing laser to generate a probing signal that is transmitted through the fiber and a probing detector to detect the probing signal. The probing laser may be a pulsed laser or a continuous-wave (CW) laser.

In this manner, it is possible to determine a parameter, such as the pressure and/or the temperature of the fluid, based on the acoustic vibrations.

More specifically, and in some embodiments, when for example the pressure and/or the temperature of the fluid changes, there may also be changes in the frequency shifts of the scattered light, for example the generated Brillouin scattered light.

In some embodiments, the probing detector is configured to detect changes in the frequency shifts of the scattered light.

Preferred embodiments of the present invention will now be described by way of example only and with reference to the accompanying drawings in which:

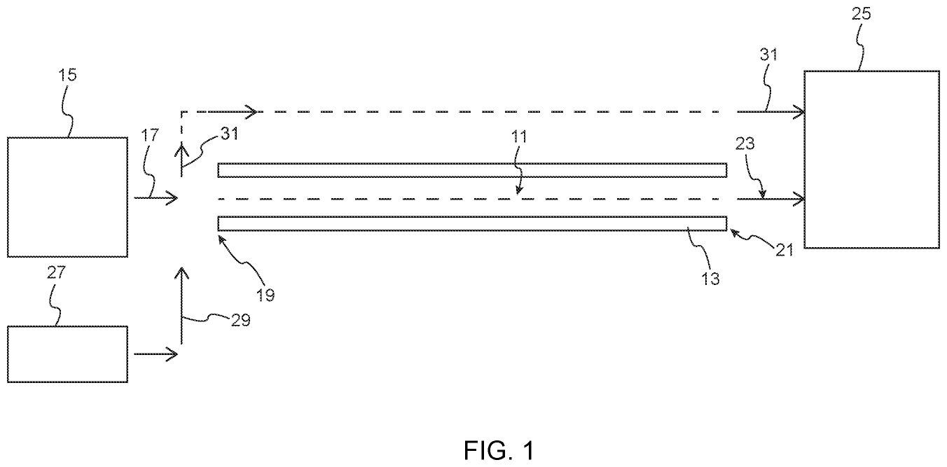

FIG. 1 shows schematically an embodiment of an optical system in accordance with the present invention;

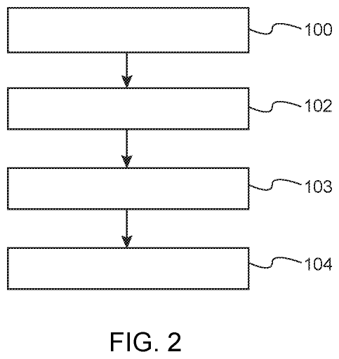

FIG. 2 shows a flow diagram of an embodiment of a method in accordance with the present invention;

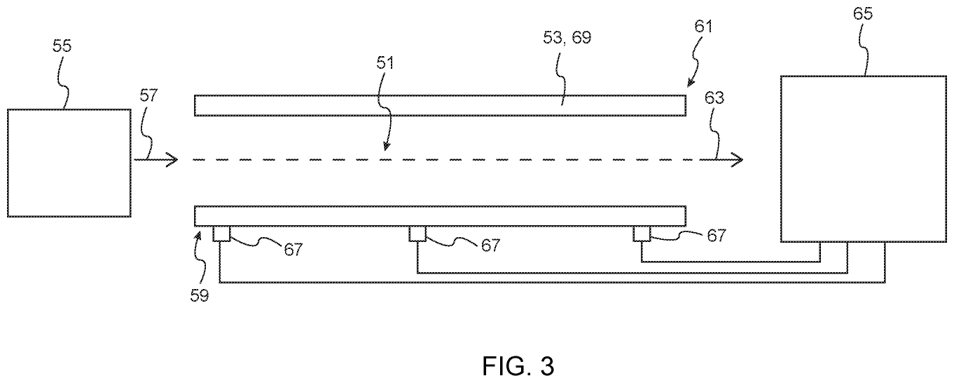

FIG. 3 shows schematically a further embodiment of an optical system in accordance with the present invention; and

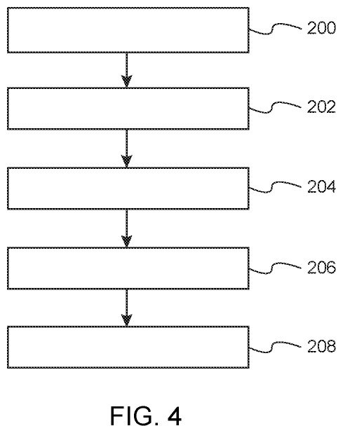

FIG. 4 shows a flow diagram of a further embodiment of a method in accordance with the present invention.

FIG. 1 shows an optical system which is configured to monitor a parameter, such as a density or a pressure, of a fluid, in particular a gas or a mixture of gases, in a hollow core 11 of an optical fiber 13.

The optical system includes the optical fiber 13 with the hollow core 11 that is filled with a fluid (not shown). In some embodiments, the fiber 13 is an anti-resonant hollow core fiber or a hollow core photonic bandgap fiber.

The optical system comprises a laser 15 for providing laser light 17. The laser 15 and the optical fiber 13 are arranged such that the laser light 17 from the laser 15 can be input into a first end 19 of the fiber 13 such that the laser light 17 propagates through the hollow core 11 from the first end 19 to a second end 21 of the fiber 13 and output laser light 23 from the laser 15 is obtained at or after the second end 21 of the fiber 13. Optionally, one or more optical elements (not shown) can be used to couple and focus the laser light 17 into the first end 19 of the fiber 13 and/or to collimate and couple the output light 23 on to following elements in the system.

The optical system also comprises a monitoring device 25 which is configured to detect the output laser light 23 (or at least a portion thereof) and to determine a parameter, such as a density or a pressure, of the fluid in the hollow core 11 based on the detected output laser light 23.

The optical system can include a second laser 27 which can provide strong laser pulses 29 that can be coupled into the first end 19 of the fiber 13, in particular by use of optical elements (not shown). The fluid in the hollow core 11 can be used as a medium which interacts with the strong laser pulses 29 and due to nonlinear effects caused by interactions between the strong laser pulses and the fluid, nonlinear optical processes, such as supercontinuum generation, four wave mixing (FWM) or self-phase modulation (SPM), can occur.

The strong laser pulses 29 can also be coupled into the second end 21 of the fiber 13, so that these pulses propagate in the opposite direction through the hollow core 11 as the laser light 17.

In some embodiments, a portion 31 is separated from the laser light 17 or 29, for example by use of a beam splitter, before the remaining laser light is input into the fiber. The portion 31 of laser light is guided around the fiber 13 and detected by the monitoring device 25. The monitoring device 25 determines the parameter, such as the density or pressure, of the fluid in the hollow core 11 based on the separated portion 31 of the laser light and the output laser light 23.

In some embodiments, the monitoring device 25 is configured to superpose the separated portion 31 of the laser light and the output laser light 23 (or a portion thereof). From the superposed signal an optical delay or, correspondingly, a phase shift, between the separated portion 31 of laser light and the output laser light 23 can be determined. The optical delay between the separated portion 31 and the output laser light 23 depends on the difference in lengths of the travel paths of the separated portion 31 and the output laser light 23. As the output laser light travels through the fluid in the hollow core 23, the optical delay also depends on the density of the fluid, since the refractive index of the fluid depends on the density. When the fluid density changes its refractive index changes and thereby the optical delay through the fiber changes. Thus, the refractive index of the fluid and the fluid density can be determined by the monitoring device 25 in dependence on the measured optical delay.

In some embodiments, it is not necessary that an absolute value of the fluid density is known. It can be sufficient to monitor changes in the fluid density. This can also be done by monitoring changes in the optical delay over time, since a change in the fluid density translates into a change of the refractive index and thus into a change of the optical delay.

In some alternative embodiments, it is not necessary to branch off the portion 31 of the laser light. Instead, the monitoring device 25 only detects the output laser light 23 (or a portion thereof).

In particular, the monitoring device 25 can be configured to monitor a phase shift of the detected output light 23 over time, for example with regard to a reference phase value. The reference phase value might correspond to the phase of a detected signal for an evacuated hollow core 11. A phase shift of the detected output light 23 is then due to the fluid in the hollow core 13. A detection of the phase shift therefore allows a determination of the density of the fluid and/or a monitoring of a change of the density over time.

In some embodiments, the laser 15 might provide laser light with a wavelength that can be modulated within a range of wavelengths that includes an absorption wavelength of the fluid. In some embodiments, the wavelength can be modulated as a function of time. In particular, the wavelength can be swept across the absorption wavelength of the fluid, and the detected output light 23 is used to determine a width of the absorption line and/or a center wavelength of the absorption line. The width of the absorption line depends on the pressure and thus on the density of the fluid in the hollow core as a higher pressure causes a broadening of the absorption line. This phenomenon is known as pressure broadening. Thus, from a detection of the width of the absorption line, a pressure of the fluid and, consequently, a density of the fluid can be determined.

In the described embodiments, the laser 15 is a continuous wave (CW) or quasi-CW laser, but the present invention is not limited to the use of such lasers. Thus, at least in some embodiments, the laser 15 can be a pulsed laser.

FIG. 2 shows a flow diagram to describe embodiments of a method for monitoring a parameter, in particular a density or a pressure, of a fluid, in an optical system as shown in FIG. 1.

The method includes a step 100 of providing an optical fiber 13 which comprises a hollow core 11 that is filled with a fluid. The method also includes a step 102 of providing laser light 17 from laser 15. In step 104, the laser light 17 (or a portion thereof) from the laser 15 is input into a first end 19 of the fiber 13 such that the laser light propagates through the hollow core 11 from the first end 19 to a second end 21 of the fiber 13, thereby obtaining output laser light 23 from the laser 15 which is output at the second end 21 of the fiber 13. In step 104, a parameter, in particular a density or a pressure, of the fluid in the hollow core 11 is determined based on the output laser light 23.

The optical system shown in FIG. 3 can also be employed for monitoring a parameter, such as a density or a pressure, of a fluid, in particular a gas or a mixture of gases, in a hollow core 51 of an optical fiber 53. In some embodiments, the optical fiber 53 is an anti-resonant hollow core fiber or a hollow core photonic bandgap fiber.

The optical system comprises in addition to the optical fiber 53 with the hollow core 51 a pulsed laser 55 for providing pulsed laser light 57. The laser 55 and the optical fiber 53 are arranged such that the pulsed laser light 57 can be input into a first end 59 of the optical fiber 53 such that the laser light 57 propagates through the hollow core 51 from the first end 59 to a second end 61 of the fiber 53. Optical elements (not shown) can serve to couple and focus the laser light 57 into the fiber 53. The pulsed laser light 57 is configured to induce nonlinear processes by interacting with the fluid in the hollow core 51. The pulses of the laser light 57 have sufficiently high peak powers to induce nonlinear processes.

The optical system further comprises a monitoring device 65 for detecting acoustic vibrations in the fiber 53 and for determining a parameter of the fluid based on the acoustic vibrations. The monitoring device 65 can comprises one or more transducers 67 arranged at one or more positions on the outer surface of the fiber 53 for detecting the acoustic vibrations. A set of transducers 67 can for example be evenly spaced along the length of the fiber 53.

A part of the energy provided by the laser pulses 57 can be absorbed by the fluid and the cladding material 69, such as glass, which surrounds the hollow core 51 of the fiber 53. The absorption can give rise to a temperature change and thermal expansion of the volume in which the laser pulses 57 are absorbed. This expansion can in turn generate a pressure wave, which propagates partly in the fluid and partly in the cladding material 69. The propagation speed of the pressure wave in the fluid depends on the temperature of the fluid and can partially be transferred to the cladding material 69. The acoustic vibrations in the cladding material 69 are monitored with the transducers 67, and the monitoring device 65 is configured to determine a parameter of the fluid based on the acoustic vibrations.

An embodiment of a method for monitoring a parameter, in particular a density or a pressure, of a fluid in a hollow core 51 of an optical fiber 53, which can be carried out by an optical system of FIG. 3 is described with regard to the flow diagram of FIG. 4.

The method according to FIG. 4 comprises a step 200 of providing the optical fiber 53 with the hollow core 51 that is filled with a fluid. In step 202, pulsed laser light 57 from laser 55 is provided. Step 204 relates to inputting the pulsed laser light 57 into the optical fiber 53 such that the laser light propagates through the hollow core 51 from the first end 59 to the second end 61. The pulsed laser light 57 has peak energies which are sufficiently high to induce nonlinear processes by interacting with the fluid in the hollow core 51. According to step 206, transducers 67 on the fiber 53 are provided to detect acoustic vibrations occurring in the fiber 53 due to the interaction between fluid and light pulses 57, and in step 208 a parameter, in particular a density or a pressure, of the fluid is determined based on the acoustic vibrations.

At least in some embodiments, each pulse from the laser 55 will set off a pressure wave when part of it is absorbed in the fiber. Part of this wave will be travelling in the cladding material 69, for example glass, where it propagates fast because the cladding material, such as glass, is a stiff material. Another part of the wave will be propagating in the fluid where it will be propagating slower as it is not a stiff a material. This part will subsequently be transmitted to the cladding material 69 to reach the side of the fiber where a transducer 67 is located. Thus, the transducer 67 can detect an initial acoustic wave from the cladding material 69 and a second weaker wave which had passed through the fluid. The speed of this second wave depends on the temperature of the fluid. Thus, the delay between the initial waves in the cladding material 69 and the second wave that passed through the fluid depends on the temperature of the fluid.

There can be absorption all along the fiber, which can lead to a much more complex acoustic wave. In addition, the acoustic wave can bounce off and be reflected by the interfaces at the fiber ends, fiber sides, and internal microstructure of the fiber in which case the detected signals are more complex to interpret. In such a case complex algorithms or a trained artificial intelligence AI can be used to infer the fluid temperature from the acoustic waves detected at a number of transducers 67. If the system is in a steady state in which the pressure is known or can be measured accurately, the local temperature of the fluid can make it possible to infer the local density.

### LIST OF REFERENCE SIGNS

11 hollow core
13 optical fiber
15 laser
17 laser light
19 first end
21 second end
23 output laser light
25 monitoring device
27 second laser
29 laser pulse
31 portion of laser light
51 hollow core
53 optical fiber
55 laser
57 laser light
59 first end
61 second end
63 output laser light
65 monitoring device
67 transducer
69 cladding material

Further details are provided by the following items.

### ITEMS

1. A method of monitoring a parameter, in particular a density or a pressure, of a fluid, in particular a gas or a mixture of gases, in a hollow core (11) of an optical fiber (13), the method comprising:
   providing an optical fiber (13) which comprises a hollow core (11) that is filled with a fluid,
   providing laser light (17) from a laser (15),
   inputting the laser light (17) from the laser (15) into a first end (19) of the fiber (13) such that the laser light (17) propagates through the hollow core (11) from the first end (19) to a second end (21) of the fiber (13), thereby obtaining output laser light (23) from the laser (15) which is output at the second end (21) of the fiber (13), and
   determining a parameter, in particular a density or a pressure, of the fluid in the hollow core (11) based on the output laser light (23).
2. The method of item 1, further comprising:
   separating a portion (31) from the laser light before it is input into the first end (19) of the fiber (13) and not inputting the separated portion (31) of the laser light (17) into the fiber (13), and
   determining the parameter of the fluid in the hollow core (11) based on the separated portion (31) of the laser light and the output laser light (23).
3. The method of item 2,
   wherein the step of determining the parameter of the fluid in the hollow core (11) comprises monitoring an interaction, in particular an interference, between the separated portion (31) of the laser light and the output laser light (23).
4. The method of item 2 or 3,
   wherein the step of determining the parameter of the fluid in the hollow core (11) comprises determining an optical delay between the separated portion (31) of the laser light and the output laser light (23), and determining the parameter of the fluid in the hollow core (11) based on the determined optical delay.
5. The method of item 1,
   wherein a phase shift of the output laser light (23) is monitored and the parameter of the fluid is determined based on the monitored phase shift.
6. The method of item 5,
   wherein the monitored phase shift is used to determine an optical delay of the output laser light (23) due to its propagation in the fiber (13), wherein the optical delay is used to determine a refractive index of the fluid in the fiber (13), and wherein the refractive index is used to determine the parameter of the fluid.
7. The method item 1,
   wherein a wavelength of the input laser light (17) is modulated over time.
8. The method of item 7,
   wherein the method further comprises:
      sweeping the wavelength across an absorption wavelength of the fluid,
      using the output laser light (23) to determine a width of the absorption line and/or a center wavelength of the absorption line, and
      determining the parameter of the fluid based on the width of the absorption line and/or the center wavelength of the absorption line.
9. The method of any one of the preceding items,
   wherein the laser light (17) is pulsed, quasi-continuous or continuous laser light.
10. The method of any one of the proceeding items,
   wherein the input laser light (17) propagates along a same optical axis in the fiber (13) as a further, second pulsed laser light (29) which is provided by another, second laser (27).
11. The method of item 10,
   wherein the second pulsed laser light (29) is input into the fiber (13) to cause the generation of nonlinear processes in the fluid, wherein the input laser light (17) propagates in the same direction or in the opposite direction as the second pulsed laser light (29).
12. A method of monitoring a parameter, in particular a density, temperature or a pressure of a fluid, in particular a gas or a mixture of gases, in a hollow core (51) of an optical fiber (53), the method comprising:
   providing an optical fiber (53) which comprises a hollow core (51) that is filled with a fluid,
   providing pulsed laser light (57) from a laser (55),
   inputting the pulsed laser light (57) into a first end (59) of the optical fiber (53) such that the laser light (57) propagates through the hollow core (51) from the first end (59) to a second end (61) of the fiber (53), wherein the pulsed laser light (57) is configured to induce nonlinear processes by interacting with the fluid in the hollow core (51),
   measuring, in particular by use of one or more transducers (67) at one or more positions on the outer surface of the fiber, acoustic vibrations occurring in the fiber (53), and
   determining a parameter, in particular a density or a pressure, of the fluid based on the acoustic vibrations.
13. The method of item 12,
   wherein the acoustic vibrations are used to determine a temperature of the fluid, and, optionally, the temperature is used to determine a density or pressure of the fluid.
14. The method of item 12 or 13,
   wherein a propagation speed of pressure waves occurring in the fluid in the hollow core (51) is determined based on the acoustic vibrations, wherein, optionally, the propagation speed is further determined based on a signal obtained from the pulsed laser light (57).
15. An optical system configured to carry out a method in accordance with any one of the preceding items.
16. An optical system for monitoring a parameter, such as a density or a pressure, of a fluid, in particular a gas or a mixture of gases, in a hollow core of an optical fiber, wherein the optical system comprises:
   an optical fiber which comprises a hollow core that is filled with a fluid,
   a pulsed laser for providing pulsed laser light, which is input into a first end of the optical fiber such that the laser light propagates through the hollow core from the first end to a second end of the fiber, wherein the pulsed laser light is configured to induce nonlinear processes by interacting with the fluid in the hollow core, and
   wherein the optical system further comprises a monitoring device for detecting acoustic vibrations in the fiber and for determining a parameter of the fluid based on the acoustic vibrations.
17. The optical system according to item 16, wherein the optical system comprises one or more transducer(s) configured to detect the acoustic vibrations.
18. The optical system according to item 17, wherein the one or more transducer(s) is/are arranged at one or more positions on the outer surface of the fiber.
19. The optical system according to any of the previous items, wherein the monitoring device is configured to determine the density of the fluid based on the acoustic vibrations and/or on a pressure obtained from the acoustic vibrations.
20. The optical system according to any of the previous items, wherein the monitoring device is configured to determine a propagation speed of pressure waves in the fluid based on the measured acoustic vibrations.
21. The optical system according to item 20, wherein the monitoring device is configured to determine the propagation speed based on a signal obtained from the pulsed laser light.
22. The optical system according to any of the previous items, wherein the monitoring device is configured to determine a temperature of the fluid based on the measured acoustic vibrations.
23. The optical system according to item 22, wherein the temperature is used to determine a density or pressure of the fluid.
24. The optical system according to any of the previous items, wherein the fluid is arranged in the hollow core of the optical fiber in a gas-tight fashion.
25. The optical system according to any of the previous items, wherein the optical fiber is an anti-resonant hollow core fiber or a hollow core photonic bandgap fiber.
26. The optical system according to item 18, wherein the pulsed laser light is configured to induce a pressure wave in the fiber, the fiber comprising a cladding material, such that a first part of the pressure wave travels in the cladding material, thereby providing an initial wave, and another part of the pressure wave travels in the fluid, and later to the cladding material, thereby providing a second wave, such that the one or more transducer(s) is configured to detect a delay between the initial wave and the second wave, the delay being used to determine the parameter of the fluid to be monitored.
27. The optical system according to item 18, wherein the pulsed laser light is configured to induce a pressure wave in the fiber, the fiber comprising a cladding material, such that a first part of the pressure wave travels in the cladding material, thereby providing an initial wave, and another part of the pressure wave travels in the fluid, and later to the cladding material, thereby providing at least a second wave, such that the one or more transducer(s) is configured to detect a first signal of the initial wave and a plurality of signals of the at least second wave, the first signal and the plurality of signals being used with trained artificial intelligence to determine the parameter of the fluid to be monitored.

1. An optical system for monitoring a parameter of a fluid, the fluid being a gas or a mixture of gases, in a hollow core of an optical fiber, wherein the optical system comprises:
an optical fiber which comprises a hollow core that is filled with a fluid,
a pulsed laser for providing pulsed laser light, which is input into a first end of the optical fiber such that the laser light propagates through the hollow core from the first end to a second end of the fiber, wherein the pulsed laser light is configured to induce nonlinear processes by interacting with the fluid in the hollow core, and
wherein the optical system further comprises a monitoring device for detecting acoustic vibrations in the fiber and for determining a parameter of the fluid based on the acoustic vibrations.

2. The optical system according to claim 1, wherein the optical system comprises at least one transducer configured to detect the acoustic vibrations.

3. The optical system according to claim 2, wherein the at least one transducer is arranged at one or more positions on the outer surface of the fiber.

4. The optical system according to claim 1, wherein the monitoring device is configured to determine the density of the fluid based on at least one of the acoustic vibrations and a pressure obtained from the acoustic vibrations.

5. The optical system according to claim 1, wherein the monitoring device is configured to determine a propagation speed of pressure waves in the fluid based on the measured acoustic vibrations.

6. The optical system according to claim 5, wherein the monitoring device is configured to determine the propagation speed based on a signal obtained from the pulsed laser light.

7. The optical system according to claim 1, wherein the monitoring device is configured to determine a temperature of the fluid based on the measured acoustic vibrations, or wherein the temperature is used to determine a density or pressure of the fluid.

8. The optical system according to claim 1, wherein the fluid is arranged in the hollow core of the optical fiber in a gas-tight fashion.

9. The optical system according to claim 1, wherein the optical fiber is an anti-resonant hollow core fiber or a hollow core photonic bandgap fiber.

10. The optical system according to claim 3, wherein the pulsed laser light is configured to induce a pressure wave in the fiber, the fiber comprising a cladding material, such that a first part of the pressure wave travels in the cladding material, thereby providing an initial wave, and another part of the pressure wave travels in the fluid, and later to the cladding material, thereby providing a second wave, such that the at least one transducer is configured to detect a delay between the initial wave and the second wave, the delay being used to determine the parameter of the fluid to be monitored.

11. The optical system according to claim 1, wherein the non-linear processes are related to multi-photon absorption that occur during the interaction of pulsed laser radiation with the fluid, and wherein a location of the multi-photon absorption along the optical fiber is configured to be controlled by a peak power of the pulsed laser.

12. The optical system according to claim 11, wherein the induced multi-photon absorption at the controlled location along the optical fiber provides an increase in light intensity, such that a pressure wave, and thereby an acoustic field, is induced at the controlled location.

13. The optical system according to claim 11, wherein the optical system comprises a controller to control the peak power of the pulsed laser, such that the multi-photon absorption is induced along the optical fiber in a controllable manner.

14. The optical system according to claim 11, wherein the optical system comprises a second or more pulsed lasers for providing second pulsed laser light, wherein the second pulsed laser light is configured to induce nonlinear processes related to multi-photon absorption that occur during the interaction of pulsed laser radiation with the fluid, and wherein a location of the multi-photon absorption along the optical fiber is configured to be controlled by at least one of (i) a peak power of the second or more pulsed laser and (ii) a time delay between the pulses of the pulsed laser light and the second pulsed laser light, wherein the second pulsed laser light is:
a. input into the first end of the optical fiber such that the laser light propagates through the hollow core from the first end to the second end of the fiber, or
b. input into the second end of the optical fiber such that the laser light propagates through the hollow core from the second end to the first end of the fiber.

15. The optical system according to claim 1, wherein the non-linear processes are related to phonon-excitation that occur during the interaction of pulsed laser radiation with the fluid, and wherein the phonon-excitation along the optical fiber is configured to be dependent on the spatial shape of the beam of the pulsed laser.
